(19) United States
(12) Patent Application Publication
(10) Pub. No.: US 2014/0284522 A1
(43) Pub. Date: Sep. 25, 2014

(54) METHOD FOR GENERATING DRIED CELLULOSE AND CELLULOSE-CONTAINING MATERIAL, AND RESWELLABLE CELLULOSE PRODUCTS PRODUCED BY THIS METHOD

(71) Applicant: JENACELL GMBH, Jena (DE)

(72) Inventors: Dagmar Fischer, Jena (DE); Astrid Müller, Jena (DE); Nadine Hessler, Mengersgereuth-Hammern (DE)

(21) Appl. No.: 14/353,777

(22) PCT Filed: Oct. 19, 2012
(86) PCT No.: PCT/DE2012/001034

§ 371 Date: Apr. 24, 2014

(30) Foreign Application Priority Data
Oct. 25, 2011 (DE) 10 2011 117 136.7

(51) Int. Cl. B01J 20/30; B01J 20/24

(52) U.S. Cl. CPC B01J 20/3042; B01J 20/24
USPC 252/194

(57) ABSTRACT

The aim of the invention is to dry cellulose and cellulose-containing materials in the shortest possible time and with the lowest possible technical costs, without disruptive stress on the cellulose and without loss of stability and efficacy of any additive substances, for example medicaments, and to reswell it as required almost completely to the original structure and consistency. According to the invention for the purpose of drying and obtaining the swellability with almost complete reconstitution of the cellulose structure and consistency the dried cellulose to be prepared or the cellulose-containing material is subjected to the adsorbent effect of a moisture binder, in particular an osmotically and/or hygroscopically effective solution and then dried regardless of any structural change to the material.

The invention relates to a method for generating dried cellulose and cellulose-containing material, in particular nanocelluloses. Furthermore, the invention includes cellulose products which are reswellable as required and which are produced according to this method.

Such cellulose products are for example used in medical (e.g. implant material, wound dressings, skin substitutes), pharmaceutical (for example drug carrier systems) and technical fields of application (such as filter and membrane systems).

It is generally known that in these fields of application different cellulose and cellulose-containing materials (e.g. nanocelluloses) are used, wherein they may be of plant as well as bacterium origin. In these cases for the most part the cellulose products are used in dried form which requires for their use a sufficient reswellability. For these uses it is comprehensively known that by drying the reswelling properties of the different cellulose products are negatively affected. In particular, here the structural changes caused by dehydration as a result of drying processes are to the fore.

Accordingly, R. Weingand (GB 316,580 A) already in the year 1928 described a treatment of regenerated cellulose with a sugar solution for obtaining the pre-specified forms after drying. The cellulose materials so treated thereafter allow reversible swelling. Since this method implies preservation of the form as well as no shrinkage of the material, in the case of a complete collapse in combination with shrinkage no complete reswelling is achieved. In particular it may be that in the case of a structural collapse, which is caused by drying, the cellulose structure cannot completely be reconstituted with this treatment method. In addition, Weingand mentions a predrying step of the cellulose which is required sometimes to avoid dilution of the sugar solution. Also the fact that regenerate cellulose due to the cellulose type II (natural cellulose of type I) has other properties, such as e.g. swelling behavior, excludes the use of this method in the case of natural celluloses.

In comparison, several working groups have dealt with the improvement and modification of the swelling properties of the individual cellulose fibers. Accordingly, in the year 1936 Dreyfus et al. (GB 453,302 A) found that with the addition of salts, such as for example sodium or potassium salts of phosphate acid, acetic acid and/or citric acid, or of sugars, such as e.g. glucose or fructose, the swellability of cellulose esters in aqueous solutions can be modified such that subsequent esterification reactions with different amino reagents can be enhanced. However, the described effect onto the swellability only relates to the change of chemically modified cellulose esters which are used for further derivatizations.

Patent GB 409,916 A discloses that fiber mixtures or also different yams on the basis of cellulose derivatives, in particular cellulose acetate, form aggregates in the case of swelling in hot aqueous solutions. With the use of salts, such as e.g. sodium or potassium phosphate and/or chloride, but also of osmotically effective substances the formation of aggregates will be avoided and a uniform bright appearance will be supported. However, the users found that in this case the use of sugars had no effect onto the swellability of the cellulose derivatives.

As opposed to this, W. Stahl and P. Krais (DE 585 272 A) report from the use of highly concentrated sugar solutions or 20% solutions of calcium chloride as a dewatering reagent for cellulose derivatives which promotes the aggregation of voids between cellulose fibers.

In all described methods for increasing the swelling properties cellulose derivatives are used and not pure natural cellulose materials. Furthermore, no subsequent drying and no reswelling once more was taken into consideration in these studies.

Besides the generally known cellulose materials in the last years, in particular the nanocelluloses, have become more important. With their nanoscale structures in comparison to common celluloses they have innovative properties, such as a large inner surface area and a very high swellability. Also for a broad use of these special celluloses, comprising bacterially synthesized nanocellulose (BNC), drying with subsequent complete reswelling is of high interest.

Drying of BNC and BNC-containing materials by means of different methods is generally known, wherein however the structure of BNC, in particular by air drying or hot pressing, is changed.

BNC in native wet condition is a hydrogel which under air drying suffers from a structural collapse which is characterized by cornification processes at the surface, by the aggregation of individual fibers, by a decrease of the amount of pores and by occurrence of shrinkage of pores (C. Clasen, B. Sultanova, T. Wilhelms, P. Heisig, W.-M. Kulicke: Effects of Different Drying Processes on the Material Properties of Bacterial Cellulose Membranes, Macromol. Symp. 244, 2006, 48-58; N. Hessler: Synthese von requellbarer sowie kurzkettiger Bakteriencellulose, Institut für Organische und Makromolekulare Chemie, Friedrich-Schiller-Universitat Jena, 2004).

As established drying methods for BNC materials in literature lyophilization (such as for example N. Hessler, D. Klemm: Alteration of bacterial nanocellulose structure by in situ modification using polyethylene glycol and carbohydrate additives, Cellulose 16, 2009, 899-910; M. Seifert, S. Hesse, V. Kabrelian, D. Klemm: Controlling the water content of never dried and reswollen bacterial cellulose by the addition of water-soluble polymers to the culture medium, J. Polym. Sci., Part A: Polym. Chem. 42, 2004, 463-470), air drying, i.a. also as hot air methods (such as for example U. Udhardt, S. Hesse, D. Klemm: Analytical Investigations of Bacterial Cellulose, Macromol. Symp. 223, 2005, 201-212; H.-P. Fink, H. J. Purz, A. Bohn, J. Kunze: Investigation of the Supramolecular Structure of Never Dried Bacterial Cellulose, Macromol. Symp. 120, 1997, 207-217; C. Clasen, B. Sultanova, T. Wilhelms, P. Heisig, W.-M. Kulicke: Effects of Different Drying Processes on the Material Properties of Bacterial Cellulose Membranes, Macromol. Symp. 244, 2006, 48-58), critical point drying (such as for example F. Liebner, E. Haimer, M. Wendland, M.-A. Neouze, K. Schlufter, P. Miethe, T. Heinze: A. Potthast, T. Rosenau, Aerogels from Unaltered Bacterial Cellulose: Application of scCO2 Drying for the Preparation of Shaped, Ultra-Lightweight Cellulosic Aerogels, Macromol. Biosci. 10, 2010, 349-352) and vacuum drying (N. Hessler: Synthese von requellbarer sowie kurzkettiger Bakteriencellulose, Institut für Organische und Makromolekulare Chemie, Friedrich-Schiller-Universitat Jena, 2004) are described.

Often, with respect to the best results which are possible for the reswelling of the dried BNC material a comprehensive preservation of the structure is desired, when the different drying methods are used. In this context lyophilization is described as the method with best results in preserving the structure, i.a. from Hessler (N. Hessler: Synthese von requellbarer sowie kurzkettiger Bakteriencellulose, Institut für Organische und Makromolekulare Chemie, Friedrich-Schiller-Universitat Jena, 2004) and Klemm et al. (D. Klemm, D. Schumann, U. Udhardt, S. Marsch: Bacterial synthesized cellulose—artificial blood vessels for microsurgery, Prog. Polym. Sci. 26, 2001, 1561-1603), and thus as a mild drying method which has the edge over air drying with respect to the conservation of the native polymer structure. However, also in the case of lyophilization partially structural aggregations occur (C. Clasen, B. Sultanova, T. Wilhelms, P. Heisig, W.-M. Kulicke: Effects of Different Drying Processes on the Material Properties of Bacterial Cellulose Membranes, Macromol. Symp. 244, 2006, 48-58), so that only limited reswelling is achieved (i.a. M. Seifert, S. Hesse, V. Kabrelian, D. Klemm: Controlling the water content of never dried and reswollen bacterial cellulose by the addition of water-soluble polymers to the culture medium, J. Polym. Sci., Part A: Polym. Chem. 42, 2004, 463-470). Critical point drying by means of exposure to supercritical carbon dioxide at 40° C. and 100 bar is described from Liebner et al. (F. Liebner, E. Haimer, M. Wendland, M.-A. Neouze, K. Schlufter, P. Miethe, T. Heinze: A. Potthast, T. Rosenau, Aerogels from Unaltered Bacterial Cellulose: Application of scCO2 Drying for the Preparation of Shaped, Ultra-Lightweight Cellulosic Aerogels, Macromol. Biosci. 10, 2010, 349-352). The material thus treated only has low residual mass, like the lyophilized samples, however after critical point drying it shows distinct structural changes in the fiber network which i.a. are characterized by the formation of a macroporous system with pore diameters of up to 100 μm. The scanning electron microscopy evaluation conducted by Hessler (N. Hessler: Synthese von requellbarer sowie kurzkettiger Bakteriencellulose, Institut für Organische and Makromolekulare Chemie, Friedrich-Schiller-Universitat Jena, 2004) of samples which have been dried under vacuum at 60° C. in a drying oven showed with respect to occurring structural changes of the dried material obtained no differences in comparison to the also conducted air drying. In the case of the described air drying and also of vacuum drying cornifications and fiber aggregations were observed.

In summary, it can be said that in all before-mentioned drying processes structural losses through modifications of the native porosity and pore structure as well as aggregations of the polymer fibers are involved (also in the case of lyophilization, which is described as a mild method, partially aggregations occur, although to a lower extent as in the case of air drying). Said structural losses reduce the reswellability of the material after drying.

In addition, drying means a high amount of costs, materials and time (lyophilization apparatuses, vacuum pumps, drying ovens). A further disadvantage of the mentioned drying methods with respect to the use of the material as a drug carrier system is the thermal and/or mechanical stress on the used drugs and excipients caused by these drying procedures.

Till today, a method for drying which results in the highest possible structural preservation contemporaneously with time and cost efficacy has not been found by experts.

The stabilization of the nanofibers by water which is missing in the case of structure-changing drying procedures results in aggregation of the micro (nano)fibers which again results in remodeling of the pore system. These structural changes hamper the penetration and the uptake of water into the BNC network. This means that BNC in said air-dried form cannot be reswelled without any troubles and without strong reduction of the water uptake capacity thereof (C. Clasen, B. Sultanova, T. Wilhelms, P. Heisig, W.-M. Kulicke: Effects of Different Drying Processes on the Material Properties of Bacterial Cellulose Membranes, Macromol. Symp. 244, 2006, 48-58; D. Klemm, D. Schumann, U. Udhardt, S. Marsch: Bacterial synthesized cellulose—artificial blood vessels for microsurgery, Prog. Polym. Sci. 26, 2001, 1561-1603; N. Hessler: Synthese von requellbarer sowie kurzkettiger Bakteriencellulose, Institut für Organische and Makromolekulare Chemie, Friedrich-Schiller-Universitat Jena, 2004).

Besides the already described trials for modifying cellulose derivatives with plant origin, experiments involving different treatments of BNC and other nanocellulose-containing materials have been conducted to maintain the reswellability of the material after drying and to control the water content of the obtained samples during synthesis.

The in situ addition of different agents results in this case in structural changes and thus also in different contents of water in the samples obtained. So Seifert et al. (M. Seifert, S. Hesse, V. Kabrelian, D. Klemm: Controlling the water content of never dried and reswollen bacterial cellulose by the addition of water-soluble polymers to the culture medium, J. Polym. Sci., Part A: Polym. Chem. 42, 2004, 463-470) described the possible control of the content of water of wet and reswollen lyophilized BNC by the addition of carboxymethylcellulose (CMC), methyl cellulose (MC) and polyvinyl alcohol (PVA) to the culture medium which in the case of CMC and MC addition resulted in an increased content of water in the samples examined, whereas a comparable PVA addition resulted in lower contents of water (reduced water retention capacity). However, these methods result in BNC composites having a changed network structure being characterized by the incorporation of the water-soluble polymers in the fiber network and/or effects onto the BNC formation through the used additives and requiring more laborious purification steps of the obtained material due to a content of nitrogen found by elementary analysis. The discussed step of lyophilization results also in reduced water absorbing ability which is shown by the generally higher content of water of the wet starting samples in comparison to the examined reswollen lyophilized samples.

Also Hessler and Klemm (N. Hessler, D. Klemm: Alteration of bacterial nanocellulose structure by in situ modification using polyethylene glycol and carbohydrate additives, Cellulose 16, 2009, 899-910) found that the addition of i.a. CMC, MC and starch derivatives to the culture medium results in structural changes of the BNC network and also in effects onto the formation of the network as well as the reswellability of the lyophilized samples.

In summary it can be said that the described methods for controlling the reswelling by the addition of additives to the fermentation medium result in changes of the native BNC network. At the same time here also structural losses are a result of the used lyophilization which are connected with a partial loss of water uptake ability by this lyophilization and thus with a reduced water retention capacity of the reswollen lyophilized BNC in comparison to the wet BNC (M. Seifert, S. Hesse, V. Kabrelian, D. Klemm: Controlling the water content of never dried and reswollen bacterial cellulose by the addition of water-soluble polymers to the culture medium, J. Polym. Sci., Part A: Polym. Chem. 42, 2004, 463-470).

In addition, B. Wei et al. (B. Wei, G. Yang, F. Hong: Preparation and evaluation of a kind of bacterial cellulose dry films with antibacterial properties, Carbohydrate Polymers, 84(1), 2011, 533-538) showed that by the incorporation of a cationic surfactant also the swellability of dried BNC through prior treatment with a solution of benzalkonium chloride and subsequent lyophilization can be enhanced. However, also this method changes the structure and the additional effort and the influence through two lyophilization steps are disadvantages with respect to an efficient, time- and cost-saving as well as material-protecting drying procedure.

But also a chemical modification of BNC by etherification of the present OH groups results in a change of the swelling behavior. Accordingly, the resulting hydroxypropyl BNC as a composite with a polytetrafluoroethylene (PTFE) film shows an increased reswelling behavior after air drying (CN 101591448 A). This can be explained by the incorporation of ether groups by which the uptake of water due to higher solubility is increased.

However, with this method a chemically modified cellulose is obtained which suffers from additional structural changes (film formation) due to fan drying used in this method. At the same time, the described parameters for chemical modification and drying do not allow the use of additives in the material prior or during the drying process without any loss of stability and efficacy of the optionally incorporated additives, such as for example drugs.

The need for drying of the sample material being wet in the native state results from the requirements which have to be fulfilled by the sample material during the use, the transport and the storage thereof. The need for a suitable drying method with the possibility of reswelling is highlighted by the easier handling of samples of dry BNC materials, the higher stability of dry samples over longer periods of storage times (lower microbial susceptibility) and the lower material and cost efforts for a respective packaging of wet BNC. In addition, from special use requirements, such as for example the use of the material in wound dressings for weeping wounds, particular requirements for controlling the moisture content result to facilitate an adequate uptake of liquid from the environment (e.g. wound exudate) without any dehydration. At the same time it must be guaranteed that the advantageous material properties of the hydrogels being wet in the native state, such as inter alia a higher stability, smooth surfaces and fast release of active ingredient, during the BNC use can be preserved and restored as possible without any substantial limitation. Since the previous drying methods (also in the case of mild drying) however result in loss of structure of the material and thus in hampered reswelling, for the use of such treated samples in practice considerable disadvantages with respect to reswelling occur.

Therefore, the object of the present invention is to dry cellulose and cellulose-containing materials in the shortest possible time and with the lowest possible technical costs, without disruptive stress on the cellulose and without loss of stability and efficacy of any additive substances, such as for example medicaments, and to reswell it as required almost completely to the original structure and consistency.

According to the present invention this object is solved by a method for generating dried cellulose and cellulose-containing material in which the cellulose or the cellulose-containing material for the purpose of drying and conservation of the swellability with almost complete reconstitution of the cellulose structure and consistency is subjected to the adsorbent effect of a moisture binder, in particular an osmotically and/or hygroscopically effective solution, and after the adsorbent exposure dried regardless of any structural change to the material.

The result of such a treatment are dried cellulose products comprising in the structure of the cellulose or the cellulose-containing material for the purpose of a swellability thereof with almost complete reconstitution of the original cellulose structure and consistency adsorbed osmotically and/or hygroscopically effective substances of said dried moisture binder.

The swelling may occur anisotropically (only with increase of thickness) as well as also isotropically (increase of all parameters thickness, width).

As a moisture binder in this case an osmotically and/or hygroscopically effective solution can be used, which in particular contains single saccharides, salts, saccharide-containing and/or saccharide-like substances, polyethylene oxides, a combination of different representatives of these moisture-binding groups of substances and/or a combination of one and/or more representatives of these moisture-binding groups of substances with one or more surfactants and/or one or more preservatives.

Besides these hygroscopic and/or osmotic properties, the substances contained in the moisture-binding solutions may also act as cryoprotectants, swelling agents, plasticizers and viscosity enhancers.

In this case, appropriately the moisture-binding solution has a concentration of osmotically active and/or hygroscopic substances of 0.01% up to the saturation limit, preferably of 5-20%.

After the exposure to said moisture binder the cellulose and/or the cellulose-containing material is dried in an arbitrary manner and regardless of a so-called structural collapse (i.e. structural change and/or loss).

Surprisingly it was shown that with said exposure to the moisture binder any arbitrary drying and in particular a drying procedure with low effort (even with per se known structural change) can be conducted and nevertheless as required an almost complete reswellability of the cellulose and/or the cellulose-containing material is possible.

The exposure to the moisture-binding solution may be effected by dipping the cellulose and/or the cellulose-containing material to be subjected to the adsorbent effect thereof into the moisture-binding solution or by spraying, dropping, brushing and/or casting this solution onto it.

However, it may also be advantageous, when the moisture binder is already added in addition to the cellulose cultivation process for the purpose of its adsorbent exposure.

Due to the osmotic and/or hygroscopic properties of the moisture binder used, in the BNC structure and at the BNC mat surface, dependent on the agent used, moisture is adsorbed, the distances of the individual cellulose chains of the network are maintained during the drying procedure and thus in a flexible manner an aggregation of the fibers is prevented.

The substances adsorptively bound to the BNC fibers during the incubation surround during air drying the individual BNC strands with a thin water film being associated to the respective substance and thus prevent aggregation of the individual BNC strands. Thus, cornification of the polymer in the case of air drying is avoided.

Optionally, only after exposing them to the reswelling medium, crystalline substances being adsorbed and/or incorporated at the surface and/or in the outer mat layers are partially solved, since in these polymer regions the longer contact with ambient air may optionally result also in a stronger dehydration than inside the mat. The dried crystals being disposed at the mat surface and/or non-crystalline substances are quickly surrounded by water and solved, when they are placed in the reswelling medium, (when from the first they are not already surrounded with a film of water) and thus facilitate an influx of water into the mat structure as well as a fast reswelling.

In addition, with the invention a higher flexibility of the cellulose chains of the dried BNC material is achieved, which again is advantageous for the reswelling thereof.

In this way a so-called structural collapse during the drying procedure is prevented and the natural pore structure and porosity (amount and size of pores) of the BNC are maintained as far as possible by the incorporated moisture binder. This results in stabilization of distances of fibers in the BNC polymer composite.

So also water adsorption by capillary action (capillarity of the dried polymer) due to the maintenance of pores and faster formation of hydrogen bonds within the polymer network by means of the incorporated moisture binder becomes possible.

Hygroscopicity and osmotic activity of the moisture binder result in increased influx of water, when the dried mats are reswelled, until a balance of the concentrations between the substance in the mat and the substance in the reswelling medium is achieved and thus the osmotic pressure caused by the incorporated substance is lowered.

General description of the moisture binders used:
hygroscopic substances (water-attracting)
osmotically active substances (osmotic effect, water-attracting)
hydrophilic, hygroscopic, also numerous hydroxyl groups
polar substances
good to very good solubility

In the following the invention should be explained in more detail with the help of embodiment examples which are shown in the figures.

They show:

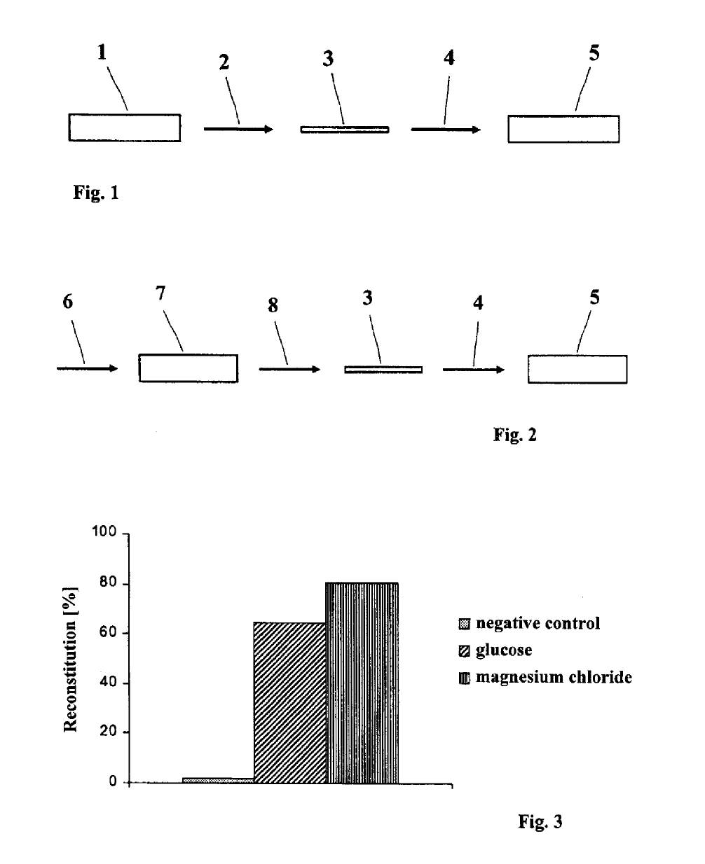

FIG. 1: Schematic diagram of the phases of the treatment of cellulose or cellulose-containing material for drying and reswelling after the cultivation process

FIG. 2: Schematic diagram of the phases of the treatment of cellulose or cellulose-containing material for drying and reswelling during the cultivation process

FIG. 3: Reconstitution (in percent) in dependence on the moisture binder used (glucose or magnesium chloride)

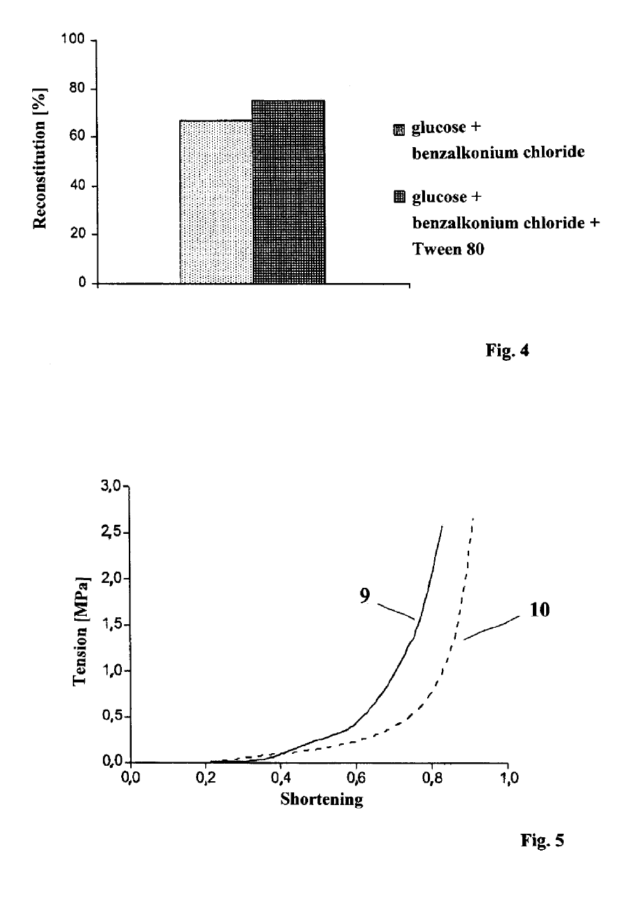

FIG. 4: Reconstitution (in percent) in dependence on a preservative (glucose and benzalkonium chloride) which is used in addition to the moisture binder or a combination of a preservative and a surfactant (glucose and benzalkonium chloride as well as Tween 80) which is used in addition to the moisture binder

FIG. 5: Tension/shortening-curve of an air-dried mat which has been treated according to the present invention after reswelling in comparison to an untreated wet standard sample (negative control).

In FIG. 1 the phases of the treatment of cellulose or cellulose-containing material for drying and reswelling after the cultivation process are shown. A cellulose 1 (wherein below this term also generally includes cellulose-containing materials) is processed in a treatment and drying process 2 to dried material 3. When required, the dried material 3 is reprocessed in a reswelling process 4 into reswollen material 5. The treatment and drying process 2 includes the exposure according to the present invention of cellulose 1 to a moisture binder, such as e.g. a saccharide, which is not shown in FIG. 1, after which the drying of the thus treated cellulose 1 is conducted, resulting in the shown dried material 3.

The treatment according to the present invention of the cellulose can be conducted during the production thereof, such as shown as a scheme in FIG. 2, also already during its cultivation process. During a cultivation 6 cellulose 7 is produced which has already been subjected to the exposure according to the present invention to an also here not shown moisture binder, such as e.g. a saccharide. Below, the term cellulose 7 also generally includes cellulose-containing materials, such as said term cellulose 1. Cellulose 7 is subjected to a drying process 8, resulting in the already in FIG. 1 shown dried material 3. As required, this material can again be reprocessed in said reswelling process 4 into the reswollen material 5 (cf. FIG. 1).

### Embodiment Example 1

Standard Drying Method and Reswelling

This example describes the generating procedure according to the present invention of dried cellulose samples as well as their reswellability, using mats consisting of bacterial nanocellulose.

The mats were incubated in 10 ml each of a 10% treatment solution, each consisting of a moisture binder, for 24 h at room temperature and under soft shaking (70 rpm). Subsequently the mats were removed from the treatment solution and dried in air, until mass constancy was achieved. The reswelling of the dried mats was conducted in 20 ml of water for injection or alternatively aqueous buffers each, again with 70 rpm. By means of this method under the same conditions mats were respectively treated with on the one hand glucose and on the other hand magnesium chloride as moisture binder and they were examined in comparison to a negative control consisting of a mat which was treated without moisture binder under the same conditions only with water for injection. The mass of the mat resulting after 168 h of reswelling was given as the measure for the reswellability and the reconstitution of the mats as the part in percent of the sample starting mass before drying. The results are shown in FIG. 3 as a comparison of the reconstitution of mats treated with glucose and magnesium chloride as moisture binder compared to the negative control. After 168 h of reswelling the mats treated with moisture binder in comparison to the negative control which was treated without moisture binder showed a reswellability which in the case of glucose-treated mats was higher by a factor of ca. 29 and in the case of magnesium chloride-treated mats was higher by a factor of ca. 36, and thus a substantially increased reswellability.

This means for the glucose-treated mats a reconstitution of 65% and for the magnesium chloride-treated mats a reconstitution of 81% in comparison to the significantly lower reconstitution of 2% for the negative control. This shows the increased reswellability of the mats treated with the moisture binder according to the present invention which was obtained by the described method.

### Embodiment Example 2

Addition of Preservatives and Surfactants

This example shows the procedure of generating dried cellulose samples according to the present invention as well as their reswellability, using mats consisting of bacterial nanocellulose with the addition of a preservative or a combination of a preservative and a surfactant.

The mats were treated by the method described in embodiment example 1 under the same conditions with glucose as the moisture binder, dried and reswollen, wherein the treatment solution besides the moisture binder contained various additives. So to the treatment solution containing the moisture binder on the one hand benzalkonium chloride (0.03%) as a preservative and on the other hand a combination of benzalkonium chloride (0.03%) and Tween 80 (0.5%) as a surfactant were added and the mats treated with it under the same conditions according to the present invention were examined.

FIG. 4 shows the comparison of this reconstitution of mats obtained after the described drying and reswelling under the same conditions which have been subjected to the treatment solution consisting of the moisture binder glucose and the preservative benzalkonium chloride, compared to mats which have been treated with the treatment solution consisting of the moisture binder glucose and a combination of the mentioned preservative and the surfactant Tween 80. After 168 h of reswelling of the dried mats, for the mats treated with the combination of glucose and benzalkonium chloride a reconstitution of 67% resulted and for the mats treated with the combination of glucose, benzalkonium chloride and Tween 80 a reconstitution of 75% resulted. In comparison to the reconstitution shown in FIG. 3 of 65% for mats which have been treated under the same conditions and with the use of a treatment solution with glucose as a moisture binder without any further additives, for mats which have been treated inclusively with the mentioned additives a slightly higher reswellability resulted.

### Embodiment Example 3

Compressive Strength

This example shows how the compressive strength of a mat of bacterial nanocellulose treated according to the present invention can be modified. The mat was treated by the method described in embodiment example 1 with glucose as a moisture binder, dried and reswollen and examined in comparison to an untreated wet standard mat which was used as a negative control under the same conditions. The measurement of the compressive strength of the described samples was conducted according to DIN EN ISO 604:2002.

In FIG. 5 the evaluation via tension/shortening curves for the mat treated according to the present invention with glucose after reswelling in comparison to the untreated negative control is shown. In the case of the same tension for the mat treated with glucose a lower shortening than for the untreated mat which was used as a negative control resulted. Thus, for the sample treated according to the present invention with glucose as a moister binder an increased compressive strength and/or a higher structural water retention capacity in comparison to the untreated negative control resulted.

### LIST OF REFERENCE SIGNS USED

1, 7—cellulose

2—treatment and drying process

3—dried material

4—reswelling process

5—reswollen material

6—cultivation of cellulose 7

8—drying process

9—glucose

10—negative control

1. A method for generating dried cellulose and cellulose-containing material, in which the cellulose or the cellulose-containing material for the purpose of drying and preserving the swellability with almost complete reconstitution of the cellulose structure and consistency is subjected to the adsorbent effect of a moisture binder and after this adsorbent exposure is dried regardless of any structural change to the material.

2. The method according to claim 1, characterized in that as the moisture binder an osmotically and/or hygroscopically effective solution is used containing in particular single saccharides, salts, saccharide-containing or saccharide-like substances, polyethylene oxides, a combination of different representatives of these moisture-binding groups of substances and/or a combination of one and/or more representatives of these moisture-binding groups of substances with one or more surfactants and/or one or more preservatives.

3. The method according to claim 1, characterized in that for further modification of the reswelling behavior in addition to the moisture binder a surfactant and/or preservative-containing solution is used.

4. The method according to claim 2, characterized in that the moisture-binding solution has a concentration of osmotically active and/or hygroscopic substances of 0.01% up to the saturation limit, preferably of 5-20%.

5. The method according to claims 2, characterized in that the surfactants and/or preservatives which are used in combination with the osmotically and/or hygroscopically effective solution are used in a concentration of 0.01% up to the saturation limit, preferably of 0.01-10%.

6. The method according to claim 1, characterized in that the cellulose or the cellulose-containing material being treated with the moisture binder is air-dried.

7. The method according to claim 1, characterized in that the cellulose or the cellulose-containing material being treated with the moisture binder is vacuum-dried.

8. The method according to claim 2, characterized in that the cellulose or the cellulose-containing material to be subjected to the adsorbent effect of the moisture-binding solution is dipped into the moisture-binding solution.

9. The method according to claim 2, characterized in that onto the cellulose or the cellulose-containing material to be subjected to the adsorbent effect of the moisture-binding solution the moisture-binding solution is sprayed, dropped, brushed or cast.

10. The method according to claim 1, characterized in that the moisture binder is already added in addition to the cellulose cultivation process for the purpose of its adsorbent exposure.

11. A dried cellulose and dried cellulose-containing material, characterized in that the structure of the cellulose or the cellulose-containing material comprises adsorbed osmotically and/or hygroscopically active substances of a dried moisture binder for the purpose of its swellability with almost complete reconstitution of the original cellulose structure and consistency.
